(19) United States
(12) Patent Application Publication
(10) Pub. No.: US 2026/0158930 A1
(43) Pub. Date: Jun. 11, 2026

(54) MOTOR DRIVE SYSTEM

(71) Applicant: SUBARU CORPORATION, Tokyo (JP)

(72) Inventor: Satoshi YOSHIZAWA, Tokyo (JP)

(21) Appl. No.: 18/706,433

(22) PCT Filed: Sep. 22, 2022
(86) PCT No.: PCT/JP2022/035365

§ 371 Date: May 1, 2024

(51) Int. Cl. B60L 7/10; B60L 15/00; H02P 23/28

(52) U.S. Cl. CPC B60L 7/10; B60L 15/007; H02P 23/28; B60L 2210/14; B60L 2240/421; B60L 2240/423; B60L 2240/547

(57) ABSTRACT

A motor drive system for an electric-powered vehicle includes a motor including one rotor and two stators. The motor is configured to output a driving force of a wheel and generate regenerative power. The motor drive system includes an inverter configured to control supply power to the two stators and control the regenerative power, a battery chargeable with the regenerative power generated by the motor, a boost circuit disposed between the inverter and the battery, a switching unit configured to switch a coupling state of the two stators with respect to the inverter between series coupling and parallel coupling, and a controller configured to control an operation of the switching unit. The controller is configured to, when causing generation of the regenerative power, control the operation of the switching unit to switch the two stators to the series coupling or the parallel coupling.

### TECHNICAL FIELD

The disclosure relates to a motor drive system.

### BACKGROUND ART

A hybrid electric vehicle and a pure electric vehicle without an internal combustion engine (hereinafter collectively referred to as an electric vehicle) include a drive motor that outputs a driving force of the vehicle. The drive motor is also used as a regenerative brake during deceleration of the vehicle, and has a function of generating electric power by using rotational torques of wheels of the vehicle (hereinafter also referred to as “regenerative power generation”). The electric power that is generated by regenerative power generation (regenerated power) is charged in a battery. Electric vehicles that have been put into practical use include one drive motor, and driving of the drive motor is controlled by one inverter (see, for example, PTL 1).

Recently, electric vehicles including multiple drive motors have been being put into practical use. Such electric vehicles include, for example, an electric vehicle including a front-wheel drive motor and a rear-wheel drive motor, and an electric vehicle including drive motors each corresponding to one of wheels of the electric vehicle. Further, electric vehicles including, as a drive motor, a double-stator axial gap motor with two stators have also been studied (see, for example, PTL 2). In such electric vehicles, inverters for driving the drive motors or stators are coupled in parallel with respect to the battery.

### CITATION LIST

### Patent Literature

PTI 1: Japanese Unexamined Patent Application Publication No. 2009-027870
PTL 2: Japanese Unexamined Patent Application Publication No. 2016-131444

### SUMMARY OF INVENTION

### Technical Problem

It is known that a voltage of regenerated power (hereinafter also referred to as a “regenerated voltage”) output from an inverter when a drive motor is used as a regenerative brake is proportional to a rotational speed of the drive motor. Accordingly, when the vehicle decelerates while traveling at low or medium speeds, the regenerated voltage may become insufficient with respect to a charge voltage of the battery. Actually, the vehicle more frequently decelerates while traveling at low or medium speeds than while traveling at high speeds.

To address this, a technique may be used in which a buck-boost circuit is disposed between the inverter and the battery. The technique involves increasing a current of the regenerated power (hereinafter also referred to as a “regenerated current”) output from the inverter on the low-voltage side if the difference between the regenerated voltage and the charge voltage of the battery is large. The increase in the regenerated current to boost the voltage to the charge voltage of the battery increases the number of times of a switching element disposed in the inverter is driven. As a result, the amount of energy lost due to heat increases, which may result in a decrease in regeneration efficiency.

The disclosure has been made in view of the above problem, and an object of the disclosure is to provide a motor drive system for an electric-powered vehicle, the motor drive system including a motor with one rotor and two stators, in which a decrease in regeneration efficiency can be suppressed when regenerated power is charged in a battery.

### Solution to Problem

To overcome the above problem, an aspect of the disclosure provides a motor drive system for an electric-powered vehicle, the motor drive system including: a motor including one rotor and two stators, the motor being configured to output a driving force of a wheel and generate regenerative power;
an inverter configured to control supply power to the two stators and control the regenerative power;
a battery chargeable with the regenerative power generated by the motor;
a boost circuit disposed between the inverter and the battery;
a switching unit configured to switch a coupling state of the two stators with respect to the inverter between series coupling and parallel coupling; and
a controller configured to control an operation of the switching unit.

The controller is configured to, when causing generation of the regenerative power, control the operation of the switching unit to switch the two stators to the series coupling or the parallel coupling.

### Advantageous Effects of Invention

As described above, according to the disclosure, in a motor drive system for an electric-powered vehicle including a motor with one rotor and two stators, a decrease in regeneration efficiency can be suppressed when regenerated power is charged in a battery.

### BRIEF DESCRIPTION OF DRAWINGS

FIG. 1 is a schematic diagram illustrating an example configuration of a vehicle to which a motor drive system according to an embodiment of the disclosure can be applied.

FIG. 2 is a block diagram illustrating an example configuration of the motor drive system according to the embodiment.

FIG. 3 is a circuit diagram illustrating an example configuration of the motor drive system according to the embodiment.

FIG. 4 is a flowchart illustrating an example operation of the motor drive system according to the embodiment.

FIG. 5 is a flowchart illustrating an example operation of the motor drive system according to the embodiment.

### DESCRIPTION OF EMBODIMENTS

Hereinafter, an exemplary embodiment of the disclosure will be described in detail with reference to the accompanying drawings. In the specification and the drawings, components having substantially the same functions and configurations are denoted by the same reference numerals, and redundant description thereof will be omitted.

### <1. Example Configuration of Vehicle>

First, an example overall configuration of a vehicle to which a motor drive system according to an embodiment of the disclosure is applied will be described. The motor drive system according to the present embodiment includes a front-wheel drive motor for driving front wheels and a rear-wheel drive motor for driving rear wheels. The present embodiment uses double-stator axial gap motors as the front-wheel drive motor and the rear-wheel drive motor.

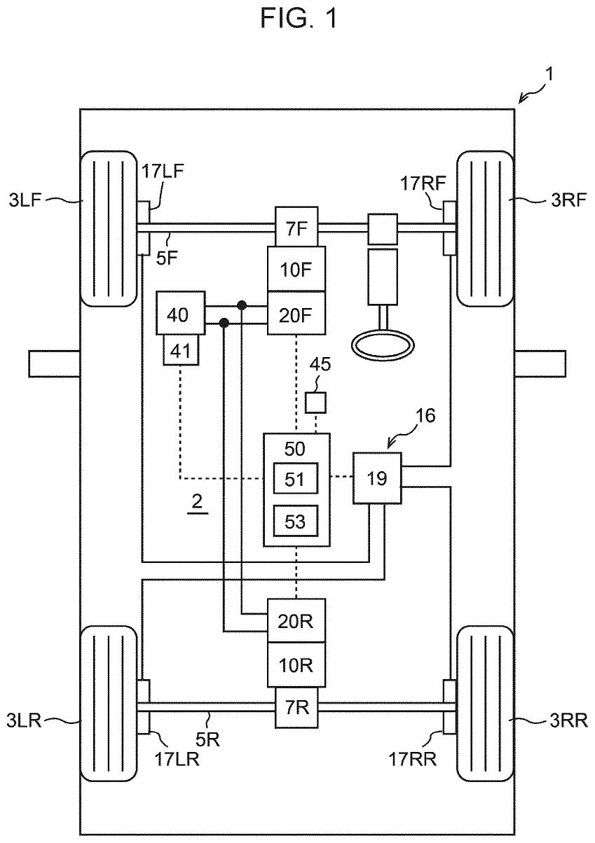

FIG. 1 is a schematic diagram illustrating an example configuration of a vehicle to which the motor drive system according to the present embodiment is applied. A vehicle 1 illustrated in FIG. 1 is a four-wheel drive electric vehicle including a left front wheel 3LF, a right front wheel 3RF, a left rear wheel 3LR, and a right rear wheel 3RR (hereinafter collectively referred to as “wheels 3” unless otherwise specified). The vehicle 1 includes a front-wheel drive motor 10F and a rear-wheel drive motor 10R as driving force sources that generate driving torques of the vehicle 1. The driving torque output from the front-wheel drive motor 10F is transmitted to the left front wheel 3LF and the right front wheel 3RF (hereinafter collectively referred to as the “front wheels 3F” unless otherwise specified). The driving torque output from the rear-wheel drive motor 10R is transmitted to the left rear wheel 3LR and the right rear wheel 3RR.

The vehicle 1 includes a motor drive system 2 and a hydraulic brake system 16. The hydraulic brake system 16 includes brake devices 17LF, 17RF, 17LR, and 17RR (hereinafter collectively referred to as brake devices 17) provided for the respective wheels 3 and a brake hydraulic pressure control device 19 that controls respective hydraulic pressures to be supplied to the brake devices 17. Each of the brake devices 17 is configured as a device that applies a braking force to a corresponding one of the wheels 3 by, for example, using the supplied hydraulic pressure to sandwich a brake disk rotating together with the corresponding one of the wheels 3 between brake pads.

The brake hydraulic pressure control device 19 includes an electric motor pump, solenoid valves, and a brake control device. The electric motor pump discharges a brake fluid. The solenoid valves adjust the respective hydraulic pressures to be supplied to the brake devices 17. The brake control device controls driving of the electric motor pump and the solenoid valves. The hydraulic brake system 16 controls the respective hydraulic pressures to be supplied to the brake devices 17 to generate predetermined braking forces on the front, rear, left, and right drive wheels 3LF, 3RF, 3LR, and 3RR. The hydraulic brake system 16 is used in combination with regenerative brakes that use the front-wheel drive motor 10F and the rear-wheel drive motor 10R.

The motor drive system 2 includes the front-wheel drive motor 10F, a front-wheel inverter unit 20F, the rear-wheel drive motor 10R, a rear-wheel inverter unit 20R, a battery 40, and a control device 50. An exemplary configuration of the motor drive system 2 will be described in detail below.

The vehicle 1 further includes a vehicle state sensor 45. The vehicle state sensor 45 is coupled to the control device 50 via a dedicated line or via a communication protocol such as a CAN (Controller Area Network) or a LIN (Local Inter Net).

The vehicle state sensor 45 includes one or more sensors that detect an operation state and a behavior (hereinafter also collectively referred to as a “vehicle state”) of the vehicle 1. The vehicle state sensor 45 includes, for example, one or more of a steering angle sensor, an accelerator position sensor, a brake stroke sensor, a brake pressure sensor, and an engine rotational speed sensor. The vehicle state sensor 45 detects an operation state of the vehicle 1, such as a steering angle of a steering wheel or steered wheels, an accelerator opening degree, an amount of brake operation, or an engine rotational speed. Further, the vehicle state sensor 45 includes, for example, one or more of a vehicle speed sensor, an acceleration sensor, and an angular velocity sensor. The vehicle state sensor 45 detects a behavior of the vehicle 1, such as a vehicle speed, a longitudinal acceleration, a lateral acceleration, or a yaw rate. The vehicle state sensor 45 transmits a sensor signal including detected information to the control device 50.

In the present embodiment, the vehicle state sensor 45 includes at least an accelerator position sensor, a brake stroke sensor, and a vehicle speed sensor. The accelerator position sensor detects an amount of accelerator pedal operation performed by a driver who drives the vehicle 1. As a non-limiting example, the accelerator position sensor may be a sensor that detects an amount of rotation of a rotary shaft of an accelerator pedal. The brake stroke sensor detects an amount of brake pedal operation performed by the driver. The brake stroke sensor may be, but not limited to, a sensor that detects an amount of movement of an output rod coupled to a brake pedal, a sensor that detects an amount of rotation of a rotary shaft of the brake pedal, or a sensor that detects a depression force of the brake pedal. The vehicle speed sensor may be, for example, but not limited to, a sensor that detects a rotational speed of any one of a rotary shaft of the front-wheel drive motor 10F and the rear-wheel drive motor 10R, a front-wheel drive shaft 5F, and a rear-wheel drive shaft 5R.

### <2. Motor Drive System>

Next, the configuration of the motor drive system 2 according to the present embodiment will be described in detail.

A motor drive system according to the present embodiment is a motor drive system for an electric-powered vehicle, including a motor including one rotor and two stators and capable of outputting a driving force of a wheel and generating regenerative power, an inverter configured to control supply power to the two stators and control the regenerative power, a battery chargeable with the regenerative power generated by the motor, a boost circuit disposed between the inverter and the battery, a switching unit configured to switch a coupling state of the two stators with respect to the inverter between series coupling and parallel coupling, and a controller configured to control an operation of the switching unit. The controller is configured to, when causing generation of the regenerative power, control the operation of the switching unit to switch the two stators to the series coupling or the parallel coupling.

The state in which the two stators are coupled in parallel indicates a coupling state of a circuit configuration in which a current supplied to one of the two stators via the inverter returns to the inverter without passing through the other stator. The state in which the two stators are coupled in series indicates a coupling state of a circuit configuration in which a current supplied to one of the two stators via the inverter returns to the inverter via the other stator.

The inverter corresponds to an inverter circuit in the following embodiment. The boost circuit corresponds to a buck-boost circuit in the following embodiment. The battery indicates, for example, a battery pack in which battery cells are coupled in series.

### (2-1. System Configuration)

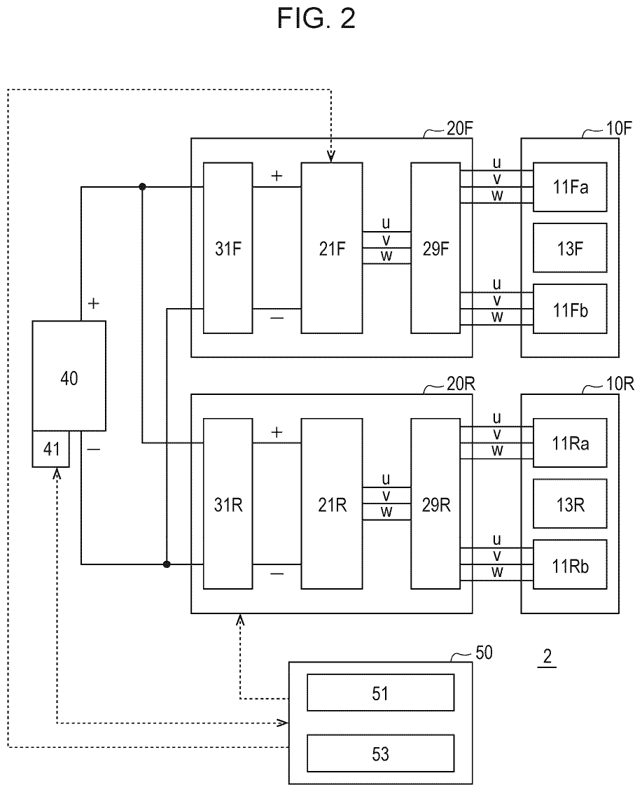

FIG. 2 is an explanatory diagram illustrating the configuration of the motor drive system according to the present embodiment, FIG. 2 is a block diagram schematically illustrating the configuration of the motor drive system.

The motor drive system 2 includes the front-wheel drive motor 10F, the front-wheel inverter unit 20F, a front-wheel converter unit 30F, the rear-wheel drive motor 10R, the rear-wheel inverter unit 20R, a rear-wheel converter unit 30R, the battery 40, and the control device 50. The battery 40 is a chargeable and dischargeable secondary battery. The battery 40 may be a lithium ion battery with a rated voltage of 200 V, for example, but the rated voltage and type of the battery 40 are not limited thereto.

The battery 40 is coupled to the front-wheel drive motor 10F via the front-wheel converter unit 30F and the front-wheel inverter unit 20F, and is coupled to the rear-wheel drive motor 10R via the rear-wheel converter unit 30R and the rear-wheel inverter unit 20R. The battery 40 stores electric power to be supplied to the front-wheel drive motor 10F and the rear-wheel drive motor 10R, The battery 40 is provided with a battery management device 41 that detects an open-circuit voltage, an output voltage, a battery temperature, and the like of the battery 40 and transmits the detected values to the control device 50.

The front-wheel drive motor 10F outputs a driving torque to be transmitted to the front wheels 3F via a front-wheel differential mechanism 7F and the front-wheel drive shaft 5F. The rear-wheel drive motor 10R outputs a driving torque to be transmitted to the rear wheels 3R via a rear-wheel differential mechanism 7R and the rear-wheel drive shaft 5R. Driving of the front-wheel drive motor 10F and the rear-wheel drive motor 10R is controlled by the control device 50. The present embodiment uses double-stator axial gap motors as the front-wheel drive motor 10F and the rear-wheel drive motor 10R.

The double-stator axial gap motors have an axial gap structure in which rotors 13F and 13R are sandwiched between first stators 11Fa and 11Ra and second stators 11Fb and 11Rb, respectively, with the first stators 11Fa and 11Ra and the second stators 11Fb and 11Rb being disposed on both sides of the rotors 13F and 13R in the direction of rotary shafts of the rotors 13F and 13R with a gap therebetween.

In the present embodiment, the front-wheel drive motor 10F and the rear-wheel drive motor 10R are configured as three-phase alternating-current motors. However, the number of phases is not limited. In the front-wheel drive motor 10F, the first stator 11Fa and the second stator 11Eb are supplied with three-phase alternating currents to form rotating magnetic fields to rotate the rotor 13F, and the front-wheel drive motor 10F outputs a driving torque. Further, the front-wheel drive motor 10F has a function of performing regenerative power generation when the rotor 13F rotates in response to receiving a rotational torque of the front wheels 3F transmitted via the front-wheel drive shaft 5F while the first stator 11Fa and the second stator 11Fb are not supplied with three-phase alternating currents. The rear-wheel drive motor 10R coupled to the rear wheels 3R also has a similar function.

The front-wheel inverter unit 20F includes a buck-boost circuit 31F, an inverter circuit 21F, and a switching unit 29F. The rear-wheel inverter unit 20R includes a buck-boost circuit 31R, an inverter circuit 21R, and a switching unit 29R. The front-wheel inverter unit 20F and the rear-wheel inverter unit 20R have the same function. The configuration and function of an inverter unit will be described hereinafter by taking the front-wheel inverter unit 20F as an example.

The buck-boost circuit 31F adjusts a voltage of power to be regenerated by the first stator 11Fa and the second stator 11Fb of the front-wheel drive motor 10F and output from the inverter circuit 21F, and supplies the adjusted voltage to the battery 40. The buck-boost circuit 31F may have a function of adjusting a voltage of a supply current when a current is to be supplied to the inverter circuit 21F. Driving of the buck-boost circuit 31F is controlled by the control device 50.

The inverter circuit 21F converts direct-current power swept from the battery 40 into three-phase alternating-current power and supplies the three-phase alternating-current power to the first stator 11Fa and the second stator 11Fb of the front-wheel drive motor 10F. The inverter circuit 21F also converts three-phase alternating-current power regenerated by the first stator 11Fa and the second stator 11Fb into direct-current power and supplies the direct-current power to the buck-boost circuit 31F, Driving of the inverter circuit 21F is controlled by the control device 50.

The switching unit 29F switches a coupling state of the first stator 11Fa and the second stator 11Fb with respect to the inverter circuit 21F between series coupling and parallel coupling. The switching unit 29F includes switches each provided for one of coils of the respective phases in the first stator 11Fa and the second stator 11Fb. In one example, the switches may be relays. In another example, the switches may be switches other than relays as long as the switches are configured such that driving of the switches can be controlled by the control device 50.

Next, the configuration of a drive circuit of a drive motor will be described in detail. A drive circuit of the front-wheel drive motor 10F and a drive circuit of the rear-wheel drive motor 11R have the same configuration. The configuration of the drive circuit of the front-wheel drive motor 10F will be described hereinafter, and the description of the configuration of the drive circuit of the front-wheel drive motor 10F will be omitted as appropriate.

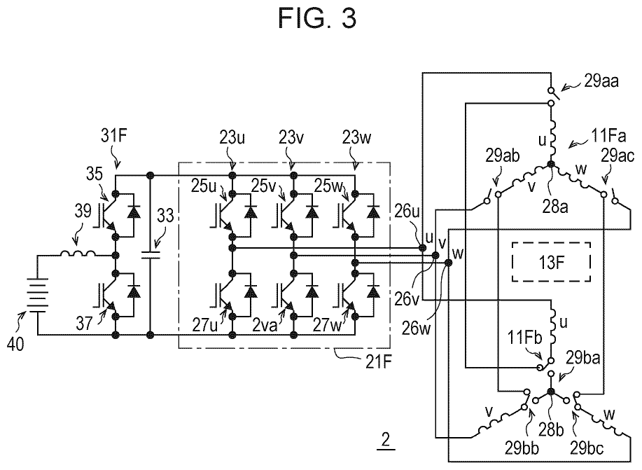

FIG. 3 is a circuit diagram of the drive circuit of the front-wheel drive motor.

The buck-boost circuit 31F includes a coil 39, two switching elements 35 and 37, and a smoothing capacitor 33. The buck-boost circuit 31F includes an upper arm electrically coupled to the upper arm side of the inverter circuit 21 and a lower arm electrically coupled to the lower arm side of the inverter circuit 21F. The upper arm and the lower arm are respectively provided with the switching elements 35 and 37 to which diodes are electrically coupled in anti-parallel. The switching elements 35 and 37 may be, for example, MOSFETs (Metal Oxide Semiconductor Field Effect Transistors) or IGBTs (Insulated Gate Bipolar Transistors), or may be any other switching elements.

One end of the coil 39 is electrically coupled to the positive electrode side of the battery 40, and the other end of the coil 39 is electrically coupled between the two switching elements 35 and 37. The smoothing capacitor 33 is coupled in parallel to the battery 40 with respect to the inverter circuit 21F. Driving of the switching elements 35 and 37 is controlled by the control device 50.

The inverter circuit 21F includes switching elements. Driving of the switching elements of the inverter circuit 21F is controlled by the control device 50. The inverter circuit 21F includes three arm circuits 23u, 23v, and 23w (hereinafter collectively referred to simply as arm circuits 23 unless otherwise specified).

The arm circuit 23u is electrically coupled to u-phase coils of the first stator 11Fa and the second stator 11Fb of the front-wheel drive motor 10F. The arm circuit 23u, the u-phase coil of the first stator 11Fa, and the u-phase coil of the second stator 11Fb are electrically coupled to one another at a branch 26u. The arm circuit 23v is electrically coupled to v-phase coils of the first stator 11Fa and the second stator 11Fb of the front-wheel drive motor 10F. The arm circuit 23v, the v-phase coil of the first stator 11Fa, and the v-phase coil of the second stator 11Fb are electrically coupled to one another at a branch 26v. The arm circuit 23w is electrically coupled to w-phase coils of the first stator 11Fa and the second stator 11Fb of the front-wheel drive motor 10F. The arm circuit 23w, the w-phase coil of the first stator 11Fa, and the w-phase coil of the second stator 11Fb are electrically coupled to one another at a branch 26w.

Each of the arm circuits 23 includes an upper arm on the upstream side of the current and a lower arm on the downstream side of the current. The upper arms of the arm circuits 23 are provided with switching elements 25u, 25v, and 25w to which diodes are electrically coupled in anti-parallel. The lower arms of the arm circuits 23 are provided with switching elements 27u, 27v, and 27w to which diodes are electrically coupled in anti-parallel. The switching elements 25u, 27u, 25v, 27v, 25w, and 27w may be, for example, MOSFETs or IGBTs, or may be any other switching elements.

The u-phase, v-phase, and w-phase coils of the first stator 11Fa of the front-wheel drive motor 10F are electrically coupled to nodes between the upper arms and the lower arms of the arm circuits 23u, 23v, and 23w, respectively. Further, the u-phase, v-phase, and w-phase coils of the first stator 11Fa are electrically coupled to one another at a node 28a. Driving of the switching elements 25u, 27u, 25v, 27, 25w, and 27w of the arm circuits 23u, 23v, and 23w is controlled by the control device 50. Accordingly, the rotational driving of the rotor 13F by the first stator 11Fa of the front-wheel drive motor 10F and the regenerative power generation by the first stator 11Fa are controlled.

Likewise, the u-phase, v-phase, and w-phase coils of the second stator 11Fb of the front-wheel drive motor 10F are electrically coupled to nodes between the upper arms and the lower arms of the arm circuits 23u, 23v, and 23w, respectively. Further, the u-phase, v-phase, and w-phase coils of the second stator 11Fb are electrically coupled to one another at a node 28b. The driving of the switching elements 25u, 27u, 25v, 27v, 25w, and 27w of the arm circuits 23u, 23v, and 23w is controlled by the control device 50. Accordingly, the rotational driving of the rotor 13F by the second stator 11Fb and the regenerative power generation by the second stator 11Fb are controlled.

The switching unit 29F includes a first switch 29aa, a second switch 29ab, and a third switch 29ac, which are provided for the u-phase, v-phase, and w-phase coils of the first stator 11Fa, respectively. The switching unit 29F further includes a fourth switch 29ba, a fifth switch 29bb, and a sixth switch 29bc, which are provided for the u-phase, v-phase, and w-phase coils of the second stator 11Eb, respectively.

The first switch 29aa is disposed between the u-phase coil of the first stator 11Fa and the branch 26u. The first switch 29aa switches electrical coupling and decoupling (on and off) between the branch 26u and the u-phase coil. The second switch 29ab is disposed between the v-phase coil of the first stator 11Fa and the branch 26v. The second switch 29ab switches electrical coupling and decoupling (on and off) between the branch 26v and the v-phase coil. The third switch 29ac is disposed between the w-phase coil of the first stator 11Fa and the branch 26w, The third switch 29ac switches electrical coupling and decoupling (on and off) between the branch 26w and the w-phase coil.

The fourth switch 29ba is disposed between the u-phase coil of the second stator 11Fb and the node 28b. The fourth switch 29ba switches between a first coupling state for coupling the u-phase coil to the node 28b of the second stator 11Fb and a second coupling state for coupling the u-phase coil to the u-phase coil of the first stator 11Fa. The fifth switch 29bb is disposed between the v-phase coil of the second stator 11Fb and the node 28b. The fifth switch 29bb switches between a first coupling state for coupling the v-phase coil to the node 28b of the second stator 11Fb and a second coupling state for coupling the v-phase coil to the v-phase coil of the first stator 11Fa. The sixth switch 29bc is disposed between the w-phase coil of the second stator 11Fb and the node 28b. The sixth switch 29bc switches between a first coupling state for coupling the w-phase coil to the node 28b of the second stator 11Fb and a second coupling state for coupling the w-phase coil to the w-phase coil of the first stator 11Fa.

The first switch 29aa, the second switch 29ab, and the third switch 29ac are turned on and the fourth switch 29ba, the fifth switch 29bb, and the sixth switch 29bc are set to the first coupling state, thereby coupling the first stator 11Fa and the second stator Fb in parallel with respect to the inverter circuit 21F. By contrast, the first switch 29aa, the second switch 29ab, and the third switch 29ac are turned off and the fourth switch 29ba, the fifth switch 29bb, and the sixth switch 29bc are set to the second coupling state, thereby coupling the first stator 11Fa and the second stator Fb in series with respect to the inverter circuit 21F.

To control powering driving of the front-wheel drive motor 10F, the control device 50 couples the first stator 11Fa and the second stator Fb in parallel with respect to the inverter circuit 21F. In this state, the control device 50 controls the driving of the switching elements of the buck-boost circuit 31F to boost the output power of the battery 40 and supply the boosted output power to the inverter circuit 21F, The boost ratio is adjusted in accordance with the on/off duty ratio of the switching elements. Further, the control device 50 controls the driving of the switching elements of the inverter circuit 21F, converts direct-current power to be supplied via the buck-boost circuit 31F into three-phase alternating-current power, and supplies the three-phase alternating-current power to the first stator 11Fa and the second stator 11Fb of the front-wheel drive motor 10F.

Further, to control regenerative driving of the front-wheel drive motor 10F, the control device 50 switches the coupling state of the first stator 11Fa and the second stator Fb with respect to the inverter circuit 21F to series coupling or parallel coupling in accordance with the regeneration efficiency. In this state, the control device 50 controls the driving of the switching elements of the inverter circuit 21F to convert three-phase alternating-current regenerated power to be output from the front-wheel drive motor 10F into direct-current power and supply the direct-current power to the buck-boost circuit 31F. Further, the control device 50 controls the driving of the switching elements of the buck-boost circuit 31F to boost the voltage of the charging current supplied to the battery 40 to a requested charge voltage of the battery 40.

### <3. Regeneration Efficiency>

The regeneration efficiency will now be described in detail by taking a drive circuit of a front-wheel drive motor as an example.

In the charging of the battery 40 with the regenerated power of the front-wheel drive motor 10F, the charge voltage is adjusted to fall within the range of the requested charge voltage of the battery 40. The control device 50 controls the driving of the switching elements of the buck-boost circuit 31F and adjusts the regenerated voltage such that the charge voltage falls within the range of the requested charge voltage of the battery 40. At this time, if regenerated voltage output from the front-wheel drive motor 10F is small, the boost ratio of the buck-boost circuit 31F is high. Thus, the regenerated current to be used in the buck-boost circuit 31F increases. In this case, the control device 50 controls the driving of the switching elements of the inverter circuit 21F to increase the regenerated current to be supplied to the buck-boost circuit 31F.

The increase in the regenerated current to be supplied to the buck-boost circuit 31F increases the number of times the switching elements of the inverter circuit 21F are driven, resulting in an increase in the amount of heat generated by the driving of the switching elements. That is, the amount of energy lost due to heat increases, and the regeneration efficiency decreases. To suppress the decrease in regeneration efficiency, it is effective to increase the regenerated voltage to be output from the front-wheel drive motor 10F and reduce the boost ratio in the buck-boost circuit 31F.

In the configuration of the motor drive system 2 according to the present embodiment, the regenerated voltages of the first stator 11Fa and the second stator 11Fb, which are generated by the rotation of the common rotor 13F, have the same value. When the first stator 11Fa and the second stator 11Fb are coupled in parallel with respect to the inverter circuit 21F, each of the first stator 11Fa and the second stator 11Fb outputs regenerated power of a voltage corresponding to the rotational speed of the rotor 13F. When the first stator 11Fa and the second stator 11Fb are coupled in parallel with respect to the inverter circuit 21F, by contrast, the regenerated voltage (second regenerated voltage) output from the front-wheel drive motor 10F is equal to the sum of the regenerated voltages of the first stator 11Fa and the second stator 11Fb.

When the vehicle decelerates from a high vehicle speed state, the rotational speed of the rotor 13F is relatively high, and the regenerated voltages of the first stator 11Fa and the second stator 11Fb are high. Thus, even in a state where the first stator 11Fa and the second stator 11Fb are coupled in parallel with respect to the inverter circuit 21F, the boost ratio in the buck-boost circuit 31F can be kept low, and the regeneration efficiency can be maintained relatively high.

When the vehicle decelerates from a low vehicle speed state, by contrast, the rotational speed of the rotor 13F is low, and the regenerated voltages of the first stator 11Fa and the second stator 11Fb are low. However, coupling the first stator 11Fa and the second stator 11Fb in series with respect to the inverter circuit 21F can double the regenerated voltage (first regenerated voltage) to be output from the front-wheel drive motor 10F. Accordingly, the boost ratio in the buck-boost circuit 31F is reduced, and a decrease in regeneration efficiency can be suppressed.

The motor drive system 2 according to the present embodiment includes the front-wheel drive motor 10F and the rear-wheel drive motor 10R. Accordingly, an increase in deceleration torque on the front wheel side during deceleration of the vehicle 1 may make a regenerative torque of the front-wheel drive motor 10F larger than a regenerative torque of the rear-wheel drive motor 10R. If the regenerative torque changes under a predetermined regenerated voltage, the regenerative torque is proportional to the regenerated current. That is, at the same regenerated voltage, the difference in regenerative torque appears as the difference in regenerated current. In the motor drive system 2, therefore, switching to series coupling or parallel coupling during regenerative driving is independently performed in each of the drive circuit of the front-wheel drive motor 10F and the drive circuit of the rear-wheel drive motor 10R.

The configuration of the control device 50 that executes a process of controlling the motor drive system 2 according to the present embodiment will be described hereinafter. After that, a process for the regenerative driving of the front-wheel drive motor 10F and the rear-wheel drive motor 10R, which is a feature of the motor drive system 2, will be described in detail.

### <3. Control Device>

### (3-1. Configuration)

The control device 50 serves as a device that controls the operation of the motor drive system 2 in response to one or more processors such as CPUs (Central Processing Units) executing a computer program. The computer program is a computer program for causing the one or more processors to execute an operation to be executed by the control device 50, which will be described below. The computer program executed by the one or more processors may be recorded in a recording medium serving as a storage (memory) 53 included in the control device 50, or may be recorded in a built-in recording medium of the control device 50 or any recording medium externally attachable to the control device 50.

Examples of the recording medium having recorded therein the computer program may include magnetic media such as a hard disk, a floppy disk, and a magnetic tape, optical recording media such as a CD-ROM (Compact Disk Read Only Memory), a DVD (Digital Versatile Disk), and Blu-ray (registered trademark), magneto-optical media such as a floptical disk, storage elements such as a RAM (Random Access Memory) and a ROM (Read Only Memory), flash memories such as a USB (Universal Serial Bus) memory and an SSD (Solid State Drive), and other media capable of storing the program.

As illustrated in FIG. 2, the control device 50 includes a processing unit 51 and a storage 53. The processing unit 51 includes one or more processors such as CPUs. Part or all of the processing unit 51 may be configured by firmware or the like that are updatable, or may be a program module or the like executed in accordance with a command from the one or more processors. However, part or all of the processing unit 51 may be configured using an analog circuit.

The storage 53 includes one or more storage elements (memories) such as a RAM or a ROM communicably coupled to the processing unit 51. However, the number and type of storages 53 are not limited. The storage 53 stores a computer program to be executed by the processing unit 51 and data such as various parameters used for arithmetic processing, detection data, and arithmetic results. The control device 50 further includes an interface (not illustrated) for communicating with the battery management device 41, the vehicle state sensor 45, and the like.

The processing unit 51 controls the driving of the inverter circuits 21F and 21R, the switching units 29F and 29R, and the buck-boost circuits 31F and 31R to control the powering driving of the front-wheel drive motor 10F and the rear-wheel drive motor 10R. In one example, the processing unit 51 acquires information on a target acceleration of the vehicle 1. If the target acceleration has a positive value, the processing unit 51 calculates target driving torques of the front-wheel drive motor 10F and the rear-wheel drive motor 10R based on the vehicle speed and the information on the target acceleration.

If the target acceleration has a positive value, the processing unit 51 determines that the first stator 11Fa (11Ra) and the second stator Fb (Rb) are coupled in parallel with respect to the inverter circuit 21F (21R). Then, the processing unit 51 controls, based on the target driving torques, the driving of the switching elements included in the inverter circuits 21F and 21R and the buck-boost circuits 31F and 31R to drive the front-wheel drive motor 10F and the rear-wheel drive motor 10R. As a result, the front-wheel drive motor 10F and the rear-wheel drive motor 10R output driving torques of the vehicle 1.

On the other hand, if the target acceleration has a negative value, the processing unit 51 calculates target regenerative torques of the front-wheel drive motor 10F and the rear-wheel drive motor 10R based on the vehicle speed and the information on the target acceleration. Further, the processing unit 51 calculates regeneration efficiency for the parallel coupling of the first stator 11Fa (11Ra) and the second stator 11Fb (11Rb) with respect to the inverter circuit 21F (21R) and regeneration efficiency for the series coupling of the first stator 11Fa (11Ra) and the second stator 11Fb (11Rb) with respect to the inverter circuit 21F (21R). The processing unit 51 sets the states of the switching units 29F and 29R such that a coupling state with high regeneration efficiency is achieved.

Then, the processing unit 51 controls, based on the calculated target regenerative torques, the driving of the switching elements included in the inverter circuits 21F and 21R and the buck-boost circuits 31F and 31R to control regeneration of the front-wheel drive motor 10F and the rear-wheel drive motor 10R. As a result, the battery 40 is charged with the regenerated power obtained by the front-wheel drive motor 10F and the rear-wheel drive motor 10R, and a regenerative brake torque is generated.

### (3-2. Example Processing Operation)

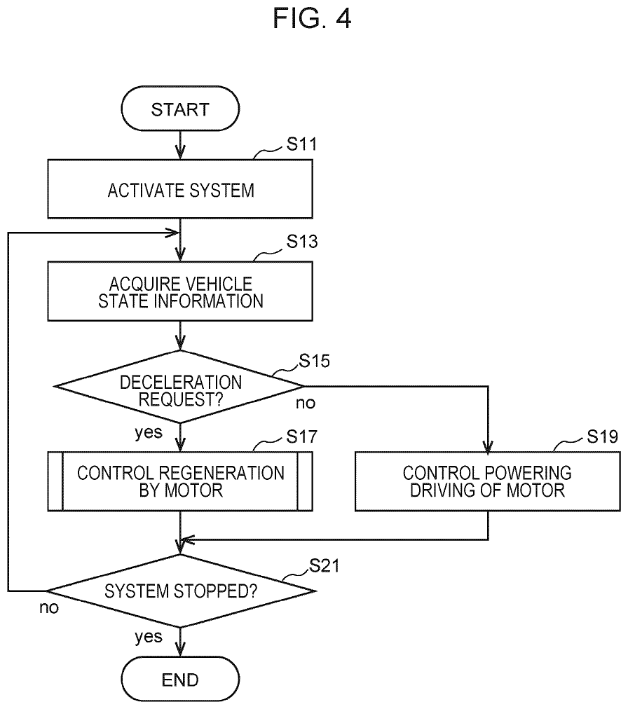

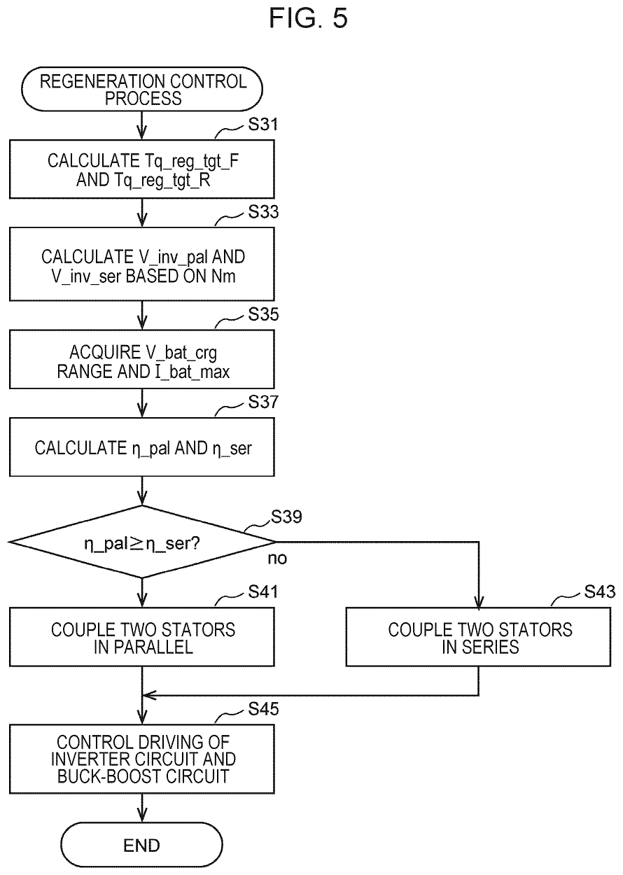

FIG. 4 and FIG. 5 are flowcharts illustrating an example processing operation performed by the control device included in the motor drive system according to the present embodiment. The flowcharts illustrated in FIG. 4 and FIG. 5 are repeatedly executed in a predetermined calculation cycle.

First, when the motor drive system 2 is activated (step S11), the processing unit 51 acquires information on the vehicle state (step S13). The information on the vehicle state includes at least information on an amount of accelerator pedal operation, an amount of brake pedal operation, and a vehicle speed. When the vehicle 1 is in automatic driving, information on requested acceleration may be acquired instead of the information on the amount of accelerator pedal operation and the amount of brake pedal operation.

Then, the processing unit 51 determines whether a deceleration request for the vehicle 1 is made (step S15). Whether the deceleration request for the vehicle 1 is made can be determined based on, for example, sensor signals of an accelerator position sensor and a brake stroke sensor. If the accelerator pedal is depressed, the processing unit 51 determines that an acceleration request is made by the driver. On the other hand, if the brake pedal is depressed or if the speed at which the amount of accelerator pedal operation is returned so as to become zero exceeds a predetermined threshold, the processing unit 51 determines that a deceleration request is made by the driver.

When the vehicle 1 is in automatic driving, the processing unit 51 determines that an acceleration request is made if the requested acceleration has a positive value, and determines that a deceleration request is made if the requested acceleration has a negative value.

If it is not determined that a deceleration request is made (S15/No), the processing unit 51 controls the powering driving of the front-wheel drive motor 10F and the rear-wheel drive motor 10R (step S19). For example, the processing unit 51 calculates target driving torques Tq_drv_tgt_F and Tq_drv_tgt_R to be output from the front-wheel drive motor 10F and the rear-wheel drive motor 10R, respectively, based on the vehicle speed and the information on the target acceleration. The target acceleration has a positive value when an acceleration request is made. The values of the target driving torques Tq_drv_tgt_F and Tq_drv_tgt_R increase as the vehicle speed increases and as the target acceleration increases. The target driving torque Tq_drv_tgt_F of the front-wheel drive motor 10F and the target driving torque Tq_drv_tgt_R of the rear-wheel drive motor 10R may be the same or different. Further, the processing unit 51 controls, based on the calculated target driving torques Tq_drv_tgt_F and Tq_drv_tgt_R, the driving of the switching elements of the buck-boost circuits 31F and 31R and the inverter circuits 21F and 21R, and performs powering driving of the front-wheel drive motor 10F and the rear-wheel drive motor 10R.

The process of controlling the powering driving of the front-wheel drive motor 10F will be described in detail by taking the front-wheel drive motor 10F as an example. For example, the processing unit 51 sets, based on the target driving torque Tq_drv_tgt_F of the front-wheel drive motor 10F and the rotational speed of the front-wheel drive motor 10F, the voltage of a direct current to be supplied to the inverter circuit 21F and the frequencies of the three-phase alternating currents to be supplied to the first stator 11Fa and the second stator 11Fb of the front-wheel drive motor 10F.

Further, the processing unit 51 controls the driving of the switching elements 35 and 37 of the buck-boost circuit 31F based on the ratio of the output voltage of the battery 40 and the voltage of the direct current to be supplied to the inverter circuit 21F to boost the voltage of a direct current to be output from the battery 40 to a set voltage. The processing unit 51 further controls the driving of the switching elements of the inverter circuit 21F, converts the direct current into a three-phase alternating current, and supplies the three-phase alternating current to the first stator 11Fa and the second stator 11Fb. As a result, the front-wheel drive motor 10F is driven, and driving torques of the vehicle 1 are output. The arithmetic processing for the powering driving of the front-wheel drive motor 10F and the rear-wheel drive motor 10R is not limited, and may be executed in accordance with an existing known arithmetic processing method.

On the other hand, if it is determined in step S15 that a deceleration request is made (S15/Yes), the processing unit 51 controls regeneration by the front-wheel drive motor 10F and the rear-wheel drive motor 10R (step S17).

FIG. 5 is a flowchart illustrating a regeneration control process.

The processing unit 51 calculates target regenerative torques Tq_reg_tgt_F and Tq_reg_tgt_R of the front-wheel drive motor 10F and the rear-wheel drive motor 10R, respectively, based on the vehicle speed and the information on the target acceleration (step S31). The target acceleration has a negative value when a deceleration request is made. Further, the values of the target regenerative torques Tq_reg_tgt_F and Tq_reg_tgt_R increase as the vehicle speed increases and as the target acceleration decreases (larger on the negative side). An upper limit may be set for the target regenerative torques Tq_reg_tgt_F and Tq_reg_tgt_R that can be set. In this case, information on brake torque insufficient for the deceleration request may be transmitted to the brake hydraulic pressure control device 19 of the hydraulic brake system 16, and the insufficient brake torque may be complemented by hydraulic brake torque.

Then, the processing unit 51 calculates, based on the rotational speeds of the front-wheel drive motor 10F and the rear-wheel drive motor 10R, a regenerated voltage V_inv_pal in the parallel coupling of the first stator 11Fa (11Ra) and the second stator 11Fb (Rb) with respect to the inverter circuit 21F (21R) and a regenerated voltage V_inv_ser in the series coupling of the first stator 11Fa (11Ra) and the second stator 11Fb (Rb) with respect to the inverter circuit 21F (21R) (step S33).

A power generation voltage E induced due to electromagnetic induction of a typical motor including a stator and a rotor can be expressed by Equation (1) below.

$$\begin{matrix}[ Math . 1 ] & \\ E = - \frac{d Φ}{d t} = B \times S \times ω \times sin θ & ( 1 )\end{matrix}$$

Φ: magnetic flux
t: time
B: magnetic flux density
S: coil area
ω: rotor angular velocity
θ: angle formed by a parallel direction of a coil surface of the stator and a perpendicular to a direction of the magnetic flux density

As illustrated in Equation (1), a regenerated voltage V_inv of the regenerated power output from the first stator 11Fa (11Ra) and the second stator 11Fb (Rb) is proportional to the angular speed (ω) of the rotor 13F (11R), that is, the rotational speeds of the front-wheel drive motor 10F and the rear-wheel drive motor 10R. The rotational speeds of the front-wheel drive motor 10F and the rear-wheel drive motor 10R are proportional to the vehicle speed. In Equation (1) above, the magnetic flux density (B) and the coil area(S) are information obtained in advance from the specifications of the front-wheel drive motor 10F and the rear-wheel drive motor 10R. Accordingly, the processing unit 51 can calculate the regenerated voltage V_inv of the first stator 11Fa (11Ra) and the second stator 11Fb (Rb) based on the vehicle speed.

In the parallel coupling of the first stator 11Fa (11Ra) and the second stator 11Fb (Rb) with respect to the inverter circuit 21F (21R), the regenerated voltage V_inv of the first stator 11Fa (11Ra) and the second stator 11Fb (Rb) is the regenerated voltage V_inv_pal of the front-wheel drive motor 10F and the rear-wheel drive motor 10R. In the series coupling of the first stator 11Fa (11Ra) and the second stator 11Fb (Rb) with respect to the inverter circuit 21F (21R), by contrast, the sum of the regenerated voltage V_inv of the first stator 11Fa (11Ra) and the second stator 11Fb (Rb) (V_inv×2) is the regenerated voltage V_inv_ser of the front-wheel drive motor 10F and the rear-wheel drive motor 10R.

In a case where a sensor or the like for detecting the rotational speeds of the front-wheel drive motor 10F and the rear-wheel drive motor 10R is disposed, the processing unit 51 may calculate the regenerated voltages V_inv_pal and V_inv_ser described above, based on the rotational speeds of the front-wheel drive motor 10F and the rear-wheel drive motor 10R instead of the vehicle speed. The rotational speed of a motor may be detected by using a sensor that detects a rotational speed of a motor shaft, or may be calculated based on a rotational speed of a drive shaft of a Wheel, which is detected by a sensor that detects the rotational speed of the drive shaft.

Then, the processing unit 51 acquires information on a requested charge voltage V_bat_crg of the battery 40 and information on a maximum charging current value I_bat_max (step 335). The information on the requested charge voltage V_bat_crg of the battery 40 and the information on the maximum charging current value I_bat_max are set in advance according to the specifications of the battery 40 and stored in the storage 53. The information on the requested charge voltage V_bat_crg of the battery 40 and the information on the maximum charging current value I_bat_max may be acquired from the battery management device 41. For example, as the open-circuit voltage of the battery 40 increases, the range of the requested charge voltage V_bat_crg is set to a higher voltage side, and the maximum charging current value I_bat_max is set to a smaller value. On the other hand, as the open-circuit voltage of the battery 40 decreases, the range of the requested charge voltage V_bat_crg is set to a lower voltage side, and the maximum charging current value I_bat_max is set to a larger value.

Then, the processing unit 51 calculates regeneration efficiency η_pal for the parallel coupling of the first stator 11Fa (11Ra) and the second stator 11Fb (Rb) with respect to the inverter circuit 21F (21R) and regeneration efficiency η_ser for the series coupling of the first stator 11Fa (11Ra) and the second stator 11Fb (Rb) with respect to the inverter circuit 21F (21R) (step S37). In one example, the processing unit 51 adds together, for each of the parallel and series couplings, the efficiency of the buck-boost circuits 31F and 31R during regenerative driving and the efficiency of the inverter circuits 21F and 21R during regenerative driving to calculate the regeneration efficiency η_pal during the parallel coupling and the regeneration efficiency η_ser during the series coupling.

The efficiency of the buck-boost circuits 31F and 31R and the efficiency of the inverter circuit 21F (21R) during regenerative driving can be each obtained by using an efficiency map. The efficiency map for the buck-boost circuits 31F and 31R is created based on data of efficiency corresponding to an input voltage, an input current, and an output voltage, the efficiency being determined in advance by using an actual machine or by simulation. Since the efficiency of the inverter circuits 21F and 21R is dominated by the loss due to the driving of the switching elements, the efficiency map for the inverter circuits 21F and 21R is created based on data of efficiency corresponding to a regenerative output, the efficiency being determined in advance by using an actual machine or by simulation.

Then, the processing unit 51 compares the regeneration efficiency η_pal during the parallel coupling and the regeneration efficiency η_ser during the series coupling, and determines whether the regeneration efficiency η_pal during the parallel coupling is equal to or greater than the regeneration efficiency η_ser during the series coupling (step S39). If the regeneration efficiency η_pal during the parallel coupling is equal to or greater than the regeneration efficiency η_ser during the series coupling (S39/Yes), the processing unit 51 switches the coupling states of the switching units 29F and 29R such that the first stator 11Fa (11Ra) and the second stator 11Fb (Rb) are coupled in parallel with respect to the inverter circuit 21F (21R) (step S41). In one example, the processing unit 51 sets the first switch 29aa, the second switch 29ab, and the third switch 29ac to the on state, and sets the fourth switch 29ba, the fifth switch 29bb, and the sixth switch 29bc to the first coupling state. In a configuration in which the first switch 29aa, the second switch 29ab, and the third switch 29ac are in the on state and the fourth switch 29ba, the fifth switch 29bb, and the sixth switch 29bc are in the first coupling state in a de-energized state, the processing unit 51 brings the switching units 29F and 29R into a de-energized state.

On the other hand, if the regeneration efficiency η_pal during the parallel coupling is less than the regeneration efficiency η_ser during the series coupling (S39/No), the processing unit 51 switches the coupling states of the switching units 29F and 29R such that the first stator 11Fa (11Ra) and the second stator 11Fb (Rb) are coupled in series with respect to the inverter circuit 21F (21R) (step S43). In one example, the processing unit 51 sets the first switch 29aa, the second switch 29ab, and the third switch 29ac to the off state, and sets the fourth switch 29ba, the fifth switch 29bb, and the sixth switch 29bc to the second coupling state. In a configuration in which the first switch 29aa, the second switch 29ab, and the third switch 29ac are in the on state and the fourth switch 29ba, the fifth switch 29bb, and the sixth switch 29bc are in the first coupling state in the de-energized state, the processing unit 51 brings the switching units 29F and 29R into an energized state.

In the present embodiment, the coupling state is switched to one of the parallel and series couplings having higher regeneration efficiency. Alternatively, in the parallel coupling, the processing unit 51 may perform control such that the boost ratio of the buck-boost circuits 31F and 31R is equal to or less than a predetermined reference value. This may suppress a decrease in regeneration efficiency.

Then, the processing unit 51 controls, based on the target regenerative torques Tq_reg_tgt_F and Tq_reg_tgt_R of the front-wheel drive motor 10F and the rear-wheel drive motor 10R and a target output voltage V_con_tgt of the buck-boost circuits 31F and 31R, the driving of the switching elements of the buck-boost circuits 31F and 31R and the inverter circuits 21F and 21R, and causes the front-wheel drive motor 10F and the rear-wheel drive motor 10R to perform regenerative power generation (step S45).

In one example, the processing unit 51 sets an on/off frequency of each of the switching elements of the inverter circuit 21F, based on the target regenerative torque Tq_reg_tgt_F of the front-wheel drive motor 10F and the rotational speed of the front-wheel drive motor 10F. Further, the processing unit 51 sets an on/off driving duty ratio of the switching elements of the buck-boost circuit 31F, based on the ratio (boost ratio) of the regenerated voltage and the requested charge voltage V_bat_crg. The processing unit 51 also sets, for the rear-wheel drive motor 10R, an on/off duty ratio of each of the switching elements of the inverter circuit 21R and the buck-boost circuit 31R.

The processing unit 51 controls the driving of the switching elements of the inverter circuits 21F and 21R and the buck-boost circuits 31F and 31R. As a result, three-phase alternating-current regenerated currents to be output from the first stators 11Fa and 11Ra and the second stators 11Fb and 11Rb of the front-wheel drive motor 10F and the rear-wheel drive motor 10R are converted into direct currents, and, in addition, the charge voltage of the battery 40 is boosted to the requested charge voltage to charge the battery 40.

After the regenerative power generation by the front-wheel drive motor 10F and the rear-wheel drive motor 10R is started in step S45, the processing unit 51 controls the target regenerative torques Tq_reg_tgt_F and Tq_reg_tgt_R of the front-wheel drive motor 10F and the rear-wheel drive motor 10R so that an output charging current to the battery 40 becomes equal to or less than the maximum charging current value I_bat_max of the battery 40. In one example, if the charging current of the battery 40 exceeds the maximum charging current value I_bat_max, the processing unit 51 sets a value obtained by subtracting the excess regenerative torque as the target regenerative torques Tq_reg_tgt_F and Tq_reg_tgt_R. In this case, the brake torque corresponding to the excess regenerative torque is added to the brake torque of the hydraulic brake system 16.

As described above, in response to a deceleration request for the vehicle, the control device switches the coupling state of the first stator and the second stator with respect to the inverter circuit between parallel coupling and series coupling such that the regeneration efficiency is increased. Accordingly, when a voltage of regenerated power output from the first stator and the second stator is low, for example, when the vehicle decelerates at a relatively low vehicle speed, the first stator and the second stator are coupled in series, and a voltage of regenerated power to be output from the drive motor to the inverter circuit can be increased. This can suppress a decrease in regeneration efficiency when regenerated power obtained by the drive motor is boosted by the buck-boost circuit to charge the battery.

While an exemplary embodiment of the disclosure has been described in detail with reference to the accompanying drawings, the disclosure is not limited to such an example. It will be apparent to a person having ordinary knowledge in the technical field to which the disclosure pertains that various changes and modifications may be made without departing from the technical scope defined by the appended claims, and it is to be understood that such changes and modifications also fall within the technical scope of the disclosure.

For example, the vehicle to which the technology of the disclosure is applicable is not limited to an electric vehicle including a front-wheel drive motor and a rear-wheel drive motor. For example, the vehicle may be an electric vehicle including one of a front-wheel drive motor and a rear-wheel drive motor, or may be an electric vehicle including one drive motor for each wheel. Even in such an electric vehicle, switching the coupling state of the first inverter and the second inverter between parallel coupling and series coupling so as to increase the regeneration efficiency in regeneration of each drive motor makes it possible to control a decrease in the regeneration efficiency in a manner similar to that described above.

In the embodiment described above, a motor drive system applied to an electric vehicle has been described as an example. However, the motor drive system of the disclosure is not limited to a motor drive system for an electric vehicle, and may be a motor drive system for a railroad or the like.

### REFERENCE SIGNS LIST

1: vehicle, 2: motor drive system, 10F: front-wheel drive motor, 10R: rear-wheel drive motor, 11Fa, 11Ra; first stator, 11Fb, 11Rb: second stator, 13F, 13R: rotor, 20F: front-wheel inverter unit, 20R: rear-wheel inverter unit, 21F, 21R: inverter circuit, 29F, 29R: switching unit, 31F, 31R: buck-boost circuit, 40: battery, 50: control device, 51: processing unit, 53: storage

1. A motor drive system for an electric-powered vehicle, the motor drive system comprising:
a motor comprising one rotor and two stators, the motor being configured to output a driving force of a wheel and generate regenerative power;
an inverter configured to control supply power to the two stators and control the regenerative power;
a battery chargeable with the regenerative power generated by the motor;
a boost circuit disposed between the inverter and the battery;
a switching unit configured to switch a coupling state of the two stators with respect to the inverter between series coupling and parallel coupling; and
a controller configured to control an operation of the switching unit, wherein
the controller is configured to, when causing generation of the regenerative power, control the operation of the switching unit to switch the two stators to the series coupling or the parallel coupling.

2. The motor drive system for an electric-powered vehicle according to claim 1, wherein the controller is configured to
when causing generation of the regenerative power, switch the two stators to the series coupling or the parallel coupling, based on a requested charge voltage of the battery and a rotational speed and a target regenerative torque of the motor.

3. The motor drive system for an electric-powered vehicle according to claim 2, wherein the controller is configured to:
when causing generation of the regenerative power, determine a first regenerated voltage in the series coupling to which the coupling state of the two stators with respect to the inverter is set and a second regenerated voltage in the parallel coupling to which the coupling state of the two stators with respect to the inverter is set, based on the rotational speed of the motor;
determine regeneration efficiency for the series coupling to which the coupling state of the two stators with respect to the inverter is set and regeneration efficiency for the parallel coupling to which the coupling state of the two stators with respect to the inverter is set, based on the first regenerated voltage, the second regenerated voltage, the requested charge voltage of the battery, and the target regenerative torque; and
switch the two stators to the series coupling or the parallel coupling to achieve higher regeneration efficiency.

4. The motor drive system for an electric-powered vehicle according to claim 3, wherein the controller is configured to
when causing generation of the regenerative power in response to switching the two stators to the parallel coupling, perform control such that a boost ratio of the boost circuit is equal to or less than a predetermined reference value.

5. The motor drive system for an electric-powered vehicle according to claim 1, wherein the electric-powered vehicle is an electric vehicle, and
wherein the motor is a single double-stator axial gap motor.
